(19) United States
(12) Patent Application Publication
(10) Pub. No.: US 2006/0121144 A1
(43) Pub. Date: Jun. 8, 2006

(54) Dispenser for a solid or pasty product

(75) Inventors: Fabrice Dieudonat, Fosses (FR); Anne-Sophie Vintimiglia, Paris (FR)

Correspondence Address: YOUNG & THOMPSON, 745 SOUTH 23RD STREET, 2ND FLOOR, ARLINGTON, VA, 22202, US

(73) Assignee: TECHPAK INTERNATIONAL, CHEVILLY-LARUE (FR)

(21) Appl. No.: 11/284,105

(22) Filed: Nov. 22, 2005

(30) Foreign Application Priority Data
Dec. 3, 2004 (FR) 04 12864

(51) Int. Cl. B28B 3/00

(52) U.S. Cl. 425/318

(57) ABSTRACT

The dispenser includes a pot designed to contain a solid or pasty product and a frame having an upper element, a lower element and a lateral element fixing the upper element and the lower element, the frame cooperating with the pot particularly when the dispenser is closed. The frame has a lower part and a upper part that can slide with respect to each other and move towards each other by an axial travel distance when an axial manual pressure is applied to the dispenser. The lower part has a base, an upper portion to close off the pot when the dispenser is closed, and an axial projection. The upper part has a lid, a lower portion and an axial projection, and the lower and upper parts cooperate by a spring.

### FIELD OF THE INVENTION

The invention relates to the domain of cosmetic product dispensers, and particularly dispensers for cosmetic products with a solid or pasty consistency, for example creams.

These cosmetic products are usually distributed in pots.

### STATE OF THE ART

Conventional pots are known that comprise a body forming a cavity that will contain the said cosmetic product with an upper opening that can be closed by a closing means.

In general, the closing means is a lid or a cap that can be screwed to the said body.

### PROBLEMS THAT ARISE

Firstly, traditional pots with a screwed lid have to be held in two hands to open and to close them, which has disadvantages in terms of manipulation and ergonomics.

Furthermore, once the lid has been unscrewed it must be placed at the side of the pot, which has the disadvantage that it takes up space and can get lost.

Secondly, packagings for cosmetic products need to be redesigned, particularly when the products themselves are renewed, to draw the attention of users of the said cosmetic products and thus encourage the purchasing act.

Finally, dispensers adapted to bathrooms are necessary, in other words dispensers that can be put down on a flat surface and can easily be used directly, and for example that can be opened with a single gesture.

### DESCRIPTION OF THE INVENTION

A dispenser for a solid or pasty product comprises a) a pot with height Hc forming a cavity that can contain the said solid or pasty product and is provided with an upper opening and a bottom, and b) a frame comprising an upper element, a lower element and a lateral element fixing the said upper and lower elements, the said frame cooperating with the said pot such that the said upper element closes off the said upper opening and the said lower element forms a support for the said pot, particularly when the said dispenser is closed.

In this dispenser:

1) the said frame comprises a so-called lower part and a so-called upper part that cooperate such as to slide with respect to each other along a typically axial and vertical direction of the said dispenser, the said lower and upper parts being capable of moving towards each other by a predetermined distance or axial travel distance ΔH when an axial manual pressure is applied to the said dispenser,

2) the said lower part comprises a base, an upper portion that will close off the said upper opening of the said pot when the said dispenser is closed, and a said first axial connecting projection between the said base and the said upper portion, the said first axial projection having a height H1p>Hc, the said base and the said upper portion forming elements typically parallel to and perpendicular to the said axial direction,

3) the said upper part comprises a lid cooperating with the said upper portion to form the said upper element, a lower portion that will form a lower support for the said pot particularly when the said dispenser is closed, the said lower portion cooperating with the said base to form the said lower element, and a said second axial connecting projection between the said lid and the said lower portion, the said second axial projection having a height H2p>Hc and cooperating with the said first axial projection to form the said lateral element, the said lid and the said lower portion forming elements typically parallel to and perpendicular to the said axial direction,

4) the said lower and upper parts cooperate particularly by means of an axial separation means, such that in the absence of the said manual pressure, the said lower and upper parts are kept at a distance from each other, and the said upper and lower portions are held close together, such that:

a) when the said dispenser is closed, the said upper and lower portions apply an axial compression on the said pot, the said upper portion then closing off and typically sealing the said upper opening,

b) and when the said axial manual pressure is applied on the said lid, the said lower portion lowering by a height equal to the said axial travel distance ΔH, the said upper and lower portions move apart by a vertical distance equal to the said axial travel distance ΔH, the said pot becomes free to move along a forwards lateral displacement to access the said upper opening, and the said dispenser can thus change from a “closed” state to an “open” state and then reversibly change from the said “open” state to the said “closed” state by a backwards lateral displacement of the said pot.

The dispenser according to the invention solves the problems that arise.

This dispenser is particularly suitable for use in the bathroom where it may be placed on a horizontal plane accessible to the user.

It is sufficient to apply an axial manual pressure on this dispenser to unlock the said pot and thus make it free to move. Ergonomically, a simple axial pressure is a much easier gesture than screwing for which the dispenser needs to be held with two hands.

Furthermore, as will become clear in the remainder of the description and in the Figures, the appearance of the dispenser according to the invention is radically different from traditional dispensers.

### DESCRIPTION OF THE FIGURES

All Figures relate to the invention.

FIGS. 1a to 2c relate to the same embodiment of a dispenser (1).

FIG. 1a shows front, top and side perspective views of the closed dispenser (1).

FIG. 1b shows a front view of the closed dispenser (1).

FIG. 1c shows a side view of the closed dispenser (1).

FIG. 2a shows a section along the vertical plane A-A in FIG. 1b.

FIG. 2b shows a section along the vertical plane B-B in FIG. 2a.

FIG. 2c shows a perspective view of the open dispenser (1).

FIGS. 3a to 3d are axial sections similar to FIG. 2a of dispensers (1) shown diagrammatically placed on a horizontal support plane (13), illustrating unlocking of the pot (2) by axial separation of the upper portion (41) and the lower portion (51). In these Figures, the said lower part (4) is shown as a continuous line, while the said upper part (5) is shown as a discontinuous line.

In the case of FIGS. 3a and 3b, the said forward lateral displacement is a translation, while it is a rotation in the case in FIGS. 3c and 3d.

FIGS. 3a and 3c represent dispensers (1) before the said axial pressure has been applied, while FIGS. 3b and 3d represent dispensers (1) while the said axial pressure is being applied, represented in FIGS. 3b and 3d by a vertical arrow in the downwards direction.

FIG. 4a is a cross-sectional view at the mid-height of a dispenser (1) along the horizontal plane A-A in FIG. 3a, the left part of the Figure showing an envelope section of the intermediate lateral element (32) of the frame (3), and the right part showing an envelope section of the said pot (2).

FIG. 4b shows a top view of the corresponding dispenser (1) in FIG. 4a, the dashed lines indicating the corresponding locations of the said lateral element (32) and the said pot (2).

FIG. 4c, similar to FIG. 4b, corresponds to the embodiment of FIGS. 1a to 2c in which, when the dispenser (1) is closed, the right and left front edges of the said pot (2) are axially aligned with the upper element (30) and the lower element (31) of the frame (3).

In FIG. 4d, which is similar to FIG. 4a, the section of the intermediate lateral element (32) was represented with axial panels (42′, 52′) engaged in each other and free to slide with respect to each other.

FIGS. 4e and 4f, corresponding to FIGS. 4a and 4b respectively, illustrate another embodiment of the dispenser (1) in which the said pot (2) has an oval section.

FIGS. 5a to 5d are similar to FIG. 4a or 4d;

In these Figures, the sections of the said lateral element (32) and the said pot (2) are complementary, so that together they form a section that is circular in FIG. 5a, oval in FIG. 5b, triangular in FIG. 5c, and approximately semi-circular in FIG. 5d.

FIGS. 6a to 6c are partial axial sections that illustrate cooperation of the upper element (30) of the frame (3) including the lid (50) and the upper portion (41), and between the two the spring (60, 61), with the upper rim (252, 252′) of a pot provided with an upper axial projection (24), the said upper portion (41) having a blocking groove (411).

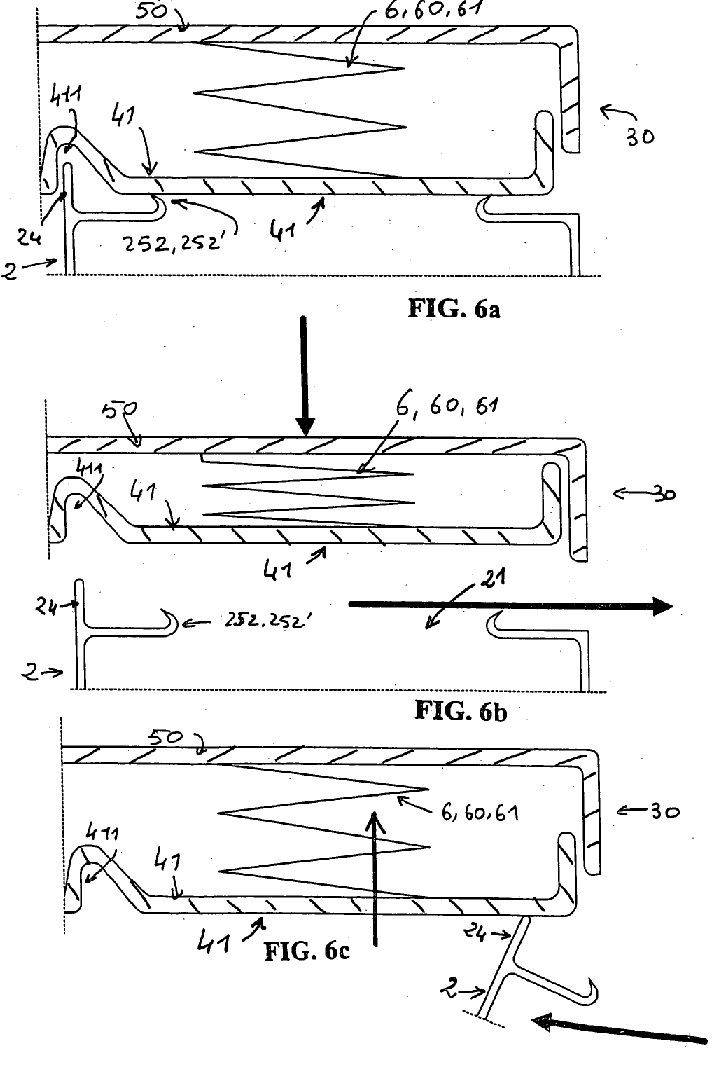

The dispenser (1) shown in FIG. 6a is closed.

An axial pressure in FIG. 6b shown diagrammatically by an arrow is applied on the lid (50), so as to release the pot (2) shown in the vertical position before it tips forwards.

In FIG. 6c, the pot (2) is represented after it has tipped forwards. In this Figure, a horizontal arrow indicates that a lateral pressure applied to the said pot (2) will cause the said pot to tip backwards, and due to the said upper axial projection (24) bearing on the said upper portion (41), will lift the said upper portion, as represented by a vertical arrow, so as to close the dispenser as shown in FIG. 6a.

### DETAILED DESCRIPTION OF THE INVENTION

According to the invention, the said lower part (4) may form a said first single-piece part, the said base (40), the said upper portion (41) and the said first axial projection (42) forming a single moulded part made of a thermoplastic material.

However, the said lower part (4) may be formed by assembling several parts.

The said upper portion (41) may form or may comprise a leak tight closing means for the said upper opening (21), the said leak tight closing means typically being formed by an add-on seal (43) fixed to the said upper portion (41) by its lower surface or by a sealing lip formed on the said upper portion (41) or on the pot.

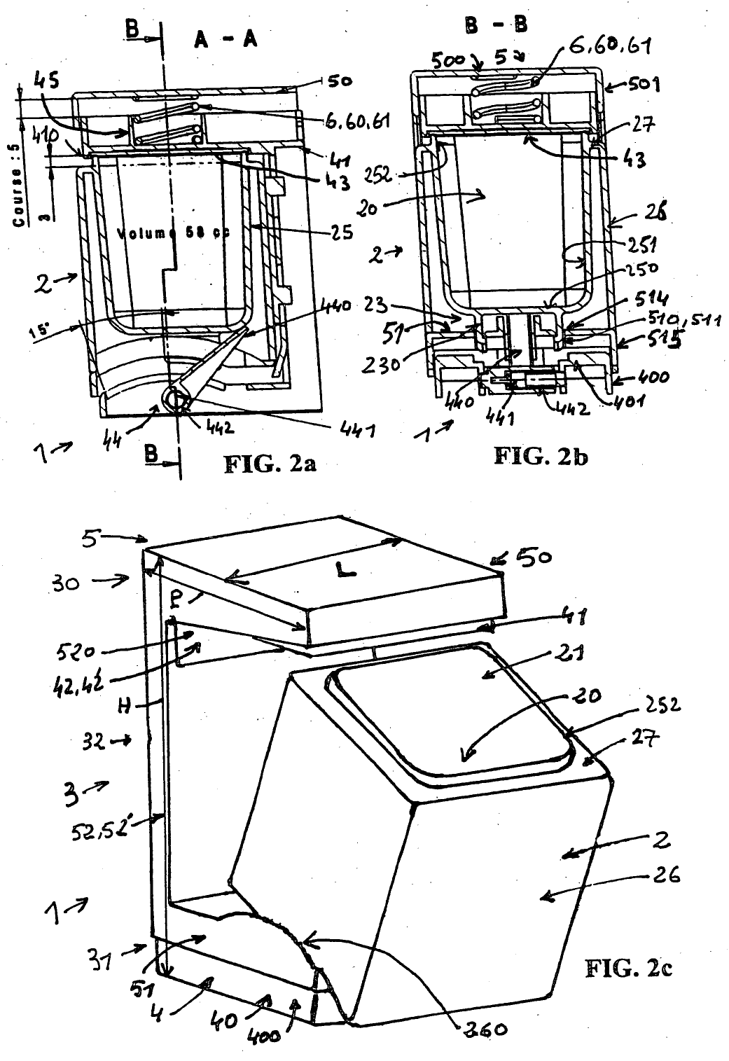

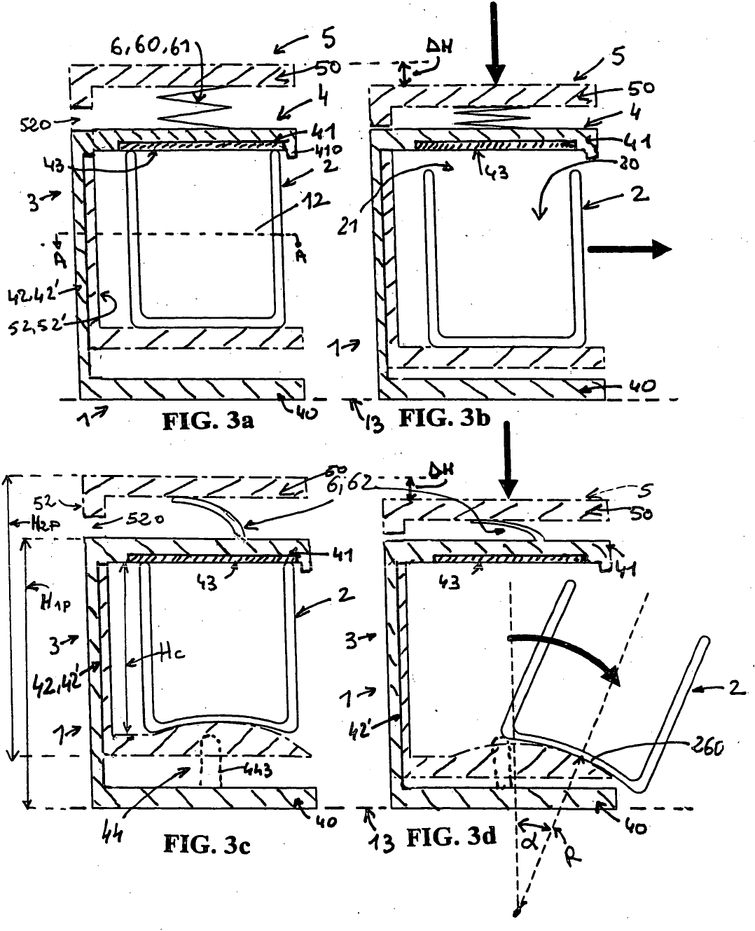

In FIGS. 2a, 2b, 3a and 3b, the leak tight closing means is formed by an add-on seal (43). In FIGS. 6a to 6c, the leak tight closing means consists of a lip (252′) formed by the upper rim (252) of the pot (2).

Advantageously, the said upper part (5) may form a said second single-piece part, the said lid (50), the said lower portion (51) and the said second axial projection (52) forming a single moulded part made of a plastic material.

As shown in FIGS. 2a, 2b and 3a to 3d, the said axial separation means (6) may be a spring or an axial spring element (60). The said spring (60) may be a helical spring (61) typically placed between the said lid and the said upper portion.

However, as illustrated in FIGS. 3c and 3d, the said spring or spring element (60) may be formed by one or several flexible and resilient tabs (62) fixed to the said lower part and/or the said upper part. In this case, the said axial separation means (6) does not form a distinct part, and forms a single part with the said lower part (4) or the said upper part (5).

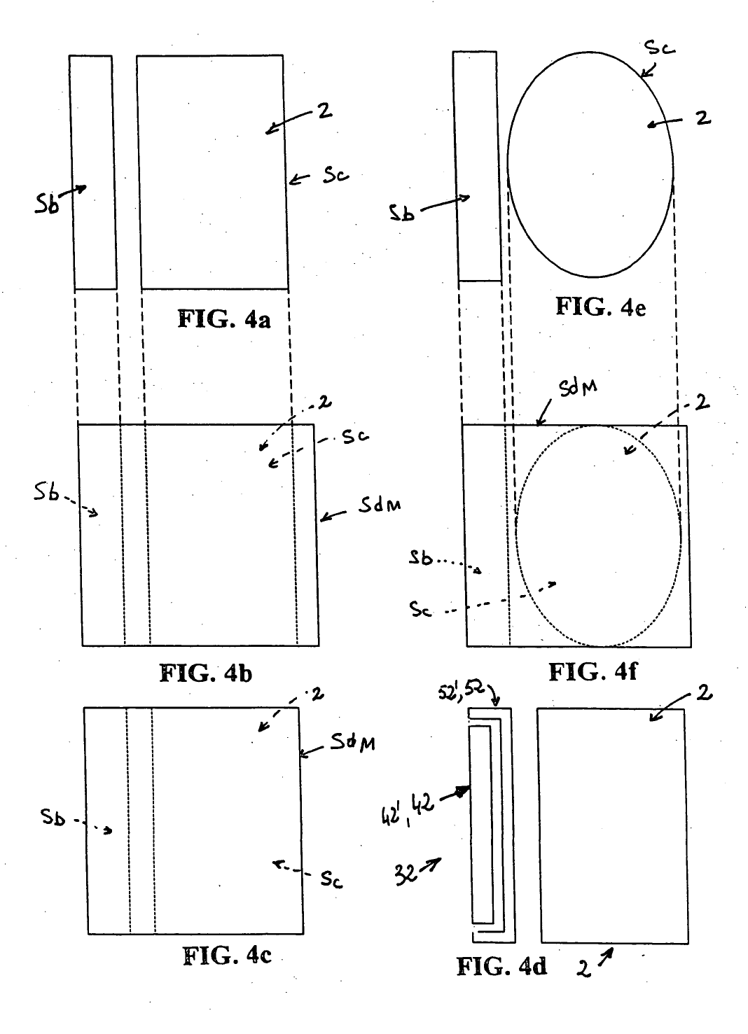

As illustrated particularly in FIGS. 4a and 4d, the said first axial projection (42) and the said second axial projection (52) can form two parallel axial panels (42′, 52′) free to slide with respect to each other and that cooperate to form the said lateral element (32) of the said frame (3), one of the two parallel axial panels (42′, 52′) being a front panel typically formed by the said second axial projection (52), the other panel being a back panel typically formed by the said first axial projection (42), the said front panel being the closest panel to the said pot (2).

As illustrated in FIGS. 2a and 2b, the said pot (2) may include a means (23) of fixing to the said frame (3) and typically to the said lower portion (51), the said fixing means (23) being used for the said lateral displacement of the said pot (2).

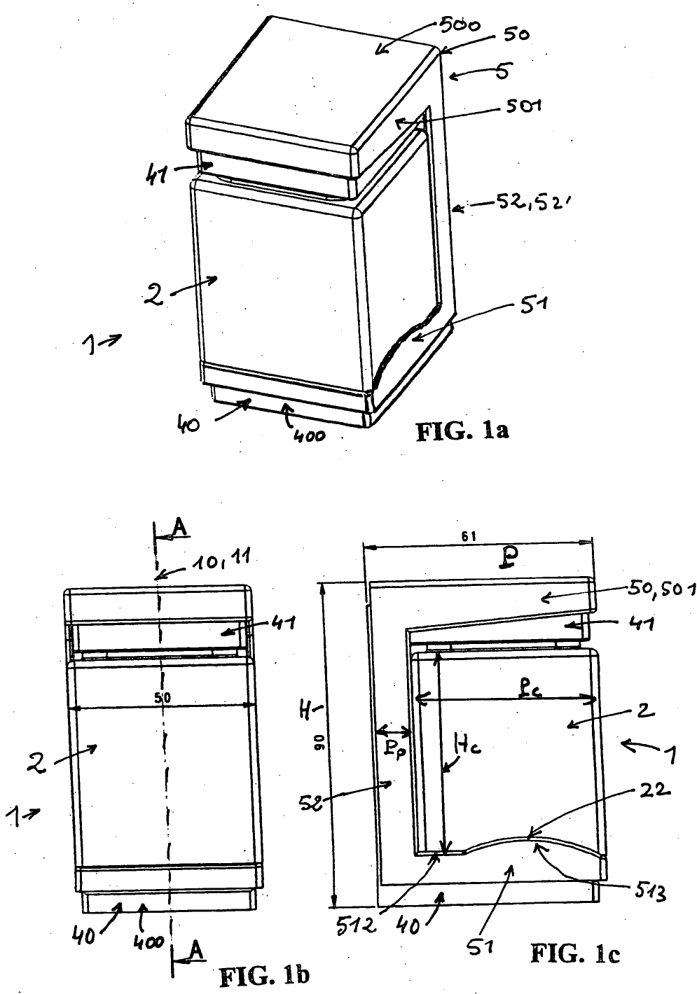

As illustrated in FIGS. 1a to 2c, 3c and particularly in FIG. 3d, the said lateral displacement may be a forward rotation or forward tipping, by an angle α in a transverse axial plane (11) perpendicular to the said front and back panels (42′, 52′) and with a radius of curvature R, the said angle α and the said radius of curvature R being chosen so as to be able to access the said upper opening (21) after the said tipping, the said angle α typically being approximately equal to α_{M} defined by tan α_{M}=Pc/Hc, where “Pc” denotes the depth of the said pot (2) in the said transverse axial plane (11) and Hc is its height.

As illustrated in FIGS. 2a and 2b, the said fixing means (23) may comprise at least one axial tab (230) cooperating with a complementary element (510) of the said lower portion (51), the said complementary element typically being formed from at least one guide element (510) of the said tab, the said guide element typically being composed of a groove or a recess (511), typically contained in the said transverse axial plane (11).

Typically, and as illustrated in FIG. 2b, the said fixing means (23) may comprise two parallel axial tabs (230) and the said guide means (510) is formed by two parallel recesses (511) into which the said axial tabs (230) click fit, such that the said pot (2) remains free to move with respect to the said lower portion (51), to enable the said lateral displacement.

As illustrated in FIGS. 1c, 2c, 3c and 3d, the said lower portion (51) may form or comprise a plane rear portion (512) and a convex front portion (513) with the said radius of curvature R on its upper surface, and in which the bottom (22) of the said pot (2) has the same radius of curvature R, so as to cooperate like a ball joint with the said convex front portion (513), such that the said pot (2) can rotate by the said angle α about the said convex front portion (513) without moving away from the said lower portion (51).

Advantageously, and as illustrated in FIG. 2a, the said base (40) may comprise a means (44) of propelling the said pot (2) forwards so as to automatically achieve the said lateral displacement of the said pot (2) so as to access the said upper opening (21), and thus make the said dispenser (1) open when the said manual pressure has been applied onto the said lid (50).

The said forward propulsion means (44) may comprise a lever (440) with an end rotating about a spindle (441) fixed to the said base (40), the said spindle (441) being in a horizontal plane (12) such that the said lever (440) can move in the said transverse axial plane (11) and a spring (442) acting on the said lever (440) so as to make the said pot (2) tip forwards as soon as the said pot (2) has been made free to move.

As illustrated in FIGS. 3c and 3d, the said forward propulsion means (44) may comprise a portion of axial rod (443) fixed to the said base (40) and located such that an upper end of the said portion of axial rod (443) bears on the bottom (22) of a lower portion of the said pot (2) during the said axial compression, thus tipping the said pot (2) forwards.

According to the invention, other means or corresponding means are possible, particularly if the lateral displacement of the pot (2) corresponds to a translation as illustrated in FIGS. 3a and 3b.

According to one embodiment of the invention, the said forward propulsion means (44) may be coupled to the said axial travel distance ΔH, typically by a notch fixed to the said lower portion cooperating with a toothed wheel fixed to the said base, such that the said dispenser (1) remains open as long as the said manual pressure is applied to the said lid (50), the said dispenser (1) automatically closing as soon as the said manual pressure is removed.

But according to another embodiment of the invention, the said forward propulsion means (44) is not necessarily coupled to the said axial travel distance ΔH, such that the said dispenser (1) remains open even if the said manual pressure applied on the said lid (50) is removed.

As illustrated in FIGS. 6a to 6c, the said pot (2) may include an upper axial projection (24) cooperating with the said upper portion (41) such that a lateral manual pressure applied on the said pot displaces the said pot along a backwards lateral displacement and thus closes the said dispenser again.

According to the invention, the said forward propulsion means (44) may be partially coupled to the said axial travel distance ΔH, such that the said dispenser (1) remains open even if the said manual pressure applied on the said lid (50) is removed, and such that all that is necessary is to apply a lateral manual pressure on the said pot to move the said pot along a backwards lateral displacement, thus closing the said dispenser.

As illustrated in FIGS. 2a to 2c, the said pot (2) may include an inner pot (25) and an outer skirt (26) with typically homothetic sections, the said outer skirt (26) being connected to the said inner pot (25) by a plane shoulder (27) the said inner pot (25) comprising a bottom (250) and an inner skirt (251) provided with an upper rim (252) above the said plane shoulder (27), the said upper rim (252) cooperating with the said upper portion (41) in a leak tight manner when the said dispenser (1) is closed.

In this case, the said axial tab (230) may be fixed to the said bottom (250) of the said inner pot (25), the said pot (2) and the said axial tab (230) typically forming a moulded single-piece part made of a thermoplastic material.

As illustrated in FIGS. 1a, 1c and 2c, 3c and 3d, the said outer skirt (26) may comprise two lateral portions or concave lower edges (260) at its lower end with the said radius of curvature R, so as to cooperate with the said convex front part (513) of the said lower portion (51) like a ball joint, such that the said pot (2) can rotate by the said angle α about the said front convex portion with radius of curvature R without separating from the said lower portion (51).

As illustrated in FIG. 2b, the said lid (50) of the said upper part (5) may comprise an upper crown (500) and an upper rim (501) surrounding the said upper portion (41) over all or some of its axial thickness, and the said lower portion (51) of the said upper part (5) may include a central portion (514) acting as a support for the said pot and a lower rim (515) surrounding the said base (40) over some of its axial thickness, such that the said lower part (4) and upper part (5) are free to slide with respect to each other along the said axial travel distance ΔH.

As illustrated in FIGS. 2c, 4a, 4d, the said pot (2) or the said outer skirt (26) of the said pot (2) may have a square or rectangular or oval or circular shaped outer cross-section Sc perpendicular to the said axial direction.

According to the invention, the said dispenser may have a height H when closed typically varying from 30 mm to 150 mm, and preferably from 50 mm to 110 mm, and a square or rectangular or oval or circular shaped maximum cross-section Sd_{M} perpendicular to the said axial direction (10), the said maximum cross-section Sd having a larger dimension Dd_{M} typically varying from 30 mm to 80 mm.

As illustrated in FIGS. 1a to 1c, the said maximum cross-section Sd_{M} may typically be constant over the entire height H, at mid-height the said dispenser (1) having a median cross-section comprising a median section Sb of the said lateral element (32) of the said frame (3) and a median section Sc of the said pot, typically such that Sd_{M}=Sb+Sc and such that the said sections are approximately complementary.

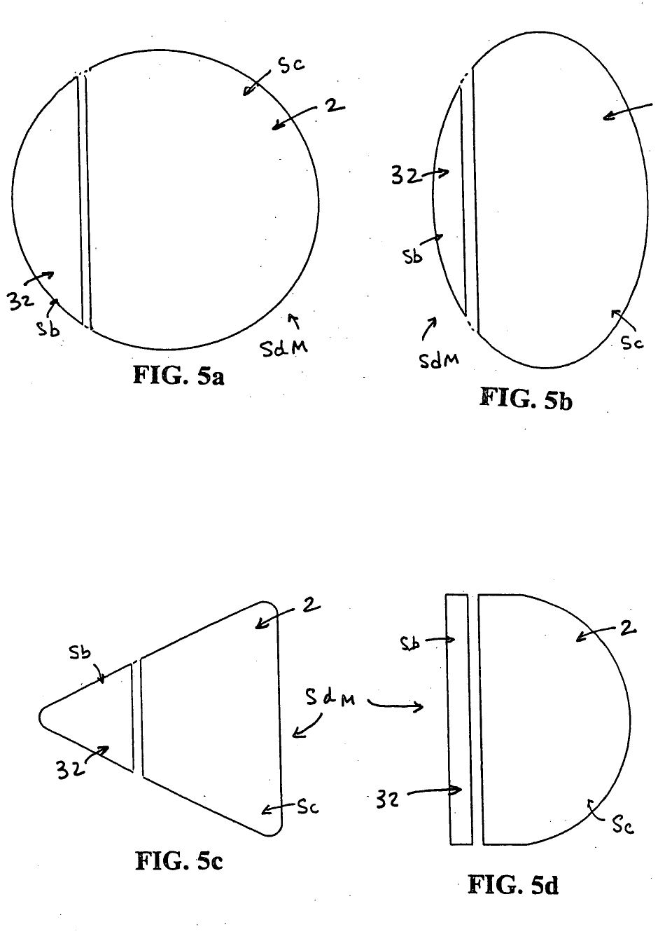

Thus, the sections are considered as being complementary in FIGS. 4a to 4d and 5a to 5d, while they are not considered to be complementary in FIGS. 4e and 4f.

As illustrated in FIG. 2c, the said dispenser may form a cube or a right-angle parallelepiped with a square or rectangular plane cross-section.

In this case, as illustrated in FIG. 4a or 4d, the said median section Sb of the said lateral element (32) of the said frame (3) may be rectangular or square, and the said median section Sc of the said pot may be square or rectangular, so as to form a rectangular or square maximum cross-section Sd_{M}.

As illustrated in FIG. 1a and FIG. 1c, the said pot (2) or the said outer skirt (26) of the said pot (2), and the said second axial projection (52) may have the same width L along a direction perpendicular to the said transverse axial plane (11), the said width L of the said dispenser typically varying from 30 mm to 80 mm, and may have depths in the said transverse axial plane (11), denoted Pc for the said pot (2) or the said outer skirt (26) of the said pot (2) and Pp for the said second axial projection (52), the sum P=Pc+Pp corresponding to the depth P of the said dispenser typically varying from 20 mm to 60 mm.

According to the invention, and as illustrated in FIGS. 4e and 4f, the said maximum cross-section Sd_{M} is not necessarily constant over the entire height, the said dispenser having a median cross-section at mid-height comprising a median section Sb of the said lateral element (32) of the said frame (3) and a median section Sc of the said pot, so as to have Sc<Sd_{M}−Sb, the median sections Sb of the said lateral element (32) of the said frame (3) and Sc of the said pot not being complementary.

Another purpose of the invention consists of a process for manufacturing the dispenser (1) according to the invention.

In this process:

1) the said lower part (4), the said upper part (5) and the said pot (2) are formed or procured,

2) the said frame (3) is formed by assembly and typically by lateral click fitting of the said lower part (4) and the upper part (5), the said pot (2) being assembled, typically by axial click fitting of the said upper part (5) to the said lower portion (51), either after or before having formed the said frame (3).

As can be seen particularly in FIGS. 3a and 3c, the said second axial projection (52) of the said upper part (5) forms an axial panel (52′) comprising a recess (520) on its upper portion to allow the said upper portion (41) of the said lower part (4) to pass.

### EXAMPLE EMBODIMENTS

A dispenser (1) was made according to FIGS. 1a to 2c.

This is done by making the following parts by moulding from a thermoplastic material:

the pot (2) provided with two axial tabs (230), the pot having a capacity or cavity volume equal to 58 cm³

the lower part (4) with a base (40) comprising an outer rim (40) and a central portion (401) comprising a rotation spindle (441) that will cooperate with a lever (440) to form the forward propulsion means (44) of the pot, and an upper portion (41) comprising an upper ring (45) in which the spring (60, 61) will be housed and a lower recess in which the add-on seal (43) will be housed the upper part (5) provided with a guide element (510) for the axial tabs (230) in the form of two parallel recesses (511) oriented in the transverse axial plane (11).

The other parts are procured or manufactured:

the helical spring (6, 60, 61),

the lever (440) and its spring (442),

the add-on seal (43).

The first step is to make a partial assembly; the spring (60, 61) and the add-on seal (43) were fixed to the upper portion (41) of the lower part (4), and the lever (440) and its spring (442) were installed on the spindle (441) of the central portion (401) of the base (40) of the lower part (4).

The next step was to assemble the lower part (4) and the upper part (5) by click fitting, the upper part (5) comprising an axial panel (52′) as a second axial projection (52), including a recess (520) in the upper portion allowing the upper portion (41) of the lower part (4) to pass. This forms the frame (3) of the dispenser (1) fitted with an upper element (30), a lower element (31) and a lateral connecting element (32).

The next step is to click fit the pot (2) to the frame (3), the tabs (230) of the pot cooperating with the recesses (511) formed on the lower portion (51) of the upper part (5).

The result is a dispenser (1) with a height H of 90 mm, a depth P of 61 mm and a width L of 50 mm.

A simple manual axial pressure applied by the product user onto the dispenser (1) placed on a support as shown diagrammatically in FIG. 3b, releases the pot (2) that tips forwards as shown in FIG. 2c, along a lateral rotation displacement of about 15°.

Thus, the upper opening (21) of the pot (2) is made accessible, as shown in FIG. 2c or FIG. 3d.

In this case, this axial pressure resulted in a predetermined axial travel distance ΔH equal to 5 mm.

Once the person has used the product, all that he needs to do to close the dispenser (1) is to apply a lateral pressure on the pot (2) such that the pot tips backwards, applying the said axial pressure simultaneously if necessary.

The closed dispenser (1) cannot be opened using the propulsion means (44) alone, firstly because the spring (60, 61) applies an axial pressure on the upper rim (252) of the pot (2), and also because the upper portion (41) of the lower part (4) comprises a retaining rim (410) that would prevent any lateral displacement of the pot, if the upper portion (41) and lower portion (51) of the frame (3) are not separated deliberately due to the said axial pressure.

Variants of the Previous Dispenser (1) were Also Made:

A dispenser (1) was also made in which the axial separation means (60) is a flexible and resilient tab (62) as illustrated in FIGS. 3c and 3d, instead of a spring (60, 61).

A dispenser (1) was also made in which the said propulsion means (44) comprise an axial rod (443) that tilts the pot as illustrated in FIGS. 3c and 3d.

Dispensers (1) with different shapes were also made:

a) cubic or parallelepiped shaped dispensers (1) are illustrated in FIGS. 1a to 2c and in FIGS. 4a to 4d,

b) other shapes, as illustrated in FIGS. 5a to 5d.

The maximum cross-section Sd_{M} of all these dispensers (1) are approximately the same over their entire height H.

However, as illustrated in FIGS. 4e and 4f, a dispenser (1) can also be made in which the top view shown in FIG. 4f is not coincident with the cross-section at mid-height.

A dispenser (1) was also made in which the upper rim (252) of the said pot (2) comprises a flexible and elastic end that can make a leak tight contact with the said upper portion (41), as illustrated in FIGS. 6a to 6c.

A dispenser (1) was also made in which, as illustrated in FIGS. 6a to 6c, the pot (2) comprises an upper axial projection (24) on its rear portion close to the said lateral element (32) of the frame (3), which makes it possible to move the said upper portion (41) upwards simply by applying a lateral pressure represented by a horizontal arrow in FIG. 6c so as to close the dispenser (1) in a single gesture.

Once the dispenser (1) is closed, the said axial projection (24) fits into a groove (411) with a depth greater than the height of the said axial projection (24) so that the upper portion (41) closes off the upper opening (21) of the pot (2) in a leak tight manner as illustrated in FIG. 6a.

### ADVANTAGES OF THE INVENTION

The packaging of solid or semi-solid products normally packaged in pots, such products typically being cosmetic products but possibly also consisting of other frequently used products and particularly household products, can be very significantly redesigned due to the use of dispensers (1) according to the invention.

In particular, these dispensers (1) offer new functions with better ergonomics and that are easier to use than traditional pots.

The invention also enables a wide variety of shapes and arrangements of a pot (2) and its frame (3) so as to offer a new image for this type of packaging, and also an image that can be customised considering the wide variety of shapes, and is therefore very advantageous in practice.

List of Marks

Dispenser 1
Axial direction 10
Transverse axial plane 11
Horizontal plane 12
Horizontal support plane 13
Pot 20
Cavity 20
Upper opening 21
Bottom 22
Means of fixing to 3 23
Axial tab 230
Upper axial projection 24
Inner pot 25
Bottom 250
Inner skirt 251
Upper rim 252
Outer skirt 26
Concave lower edge 260
Connection shoulder between 25 and 26 27
Frame 3
Upper element or lid 30
Lower element or support 31
Intermediate lateral element connecting 30 and 31 32
Lower part 4
Base 40
Outer rim 400
Central part, support for 44 401
Upper portion 41
Retaining rim for 2 410
Blocking groove for 24 411
First axial projection between 40 and 41 42
Axial panel 42′
Add-on seal 43
Forward propulsion means for 2 44
Lever 440
Rotation axis (hinge) 441
Spring 442
Axial rod 443
Retaining ring for spring 60, 61 45
Upper part 5
Lid 50
Upper crown 500
Upper rim 501
Lower portion 51
Guide element for 230 510
Recess 511
Plane rear portion 512
Front convex portion with radius R 513
Central portion 514
Lower rim 515
Second axial projection between 50 and 51 52
Axial panel 52′
Recess through which 41 can pass 520
Axial separation means 6
Spring or spring element 60
Helical spring 61
Flexible and resilient tab 62

1. Dispenser (1) for a solid or pasty product comprising a) a pot with height Hc forming a cavity (20) that will contain the said solid or pasty product and provided with an upper opening (21) and a bottom (22), and b) a frame (3) comprising an upper element, a lower element (31) and a lateral element (32) fixing the said upper element (30) and lower element, the said frame (3) cooperating with the said pot (2) such that the said upper element (30) closes off the said upper opening (21) and the said lower element (31) forms a support for the said pot (2), particularly when the said dispenser (1) is closed, in which:
1) the said frame (3) comprises a so-called lower part (4) and a so-called upper part (5) that cooperate so as to slide with respect to each other along a typically axial and vertical direction (10) of the said dispenser (1), the said lower part (4) and upper part (5) being capable of moving towards each other by a predetermined distance or axial travel distance ΔH when an axial manual pressure is applied to the said dispenser (1),
2) the said lower part (4) comprises a base (40), an upper portion (41) that will close off the said upper opening (21) of the said pot (2) when the said dispenser (1) is closed, and a so-called first axial connecting projection (42) between the said base (40) and the said upper portion (41), the said first axial projection (42) having a height H1p>Hc, the said base (40) and the said upper portion (41) forming elements typically parallel to and perpendicular to the said axial direction (10),
3) the said upper part (5) comprises a lid (50) cooperating with the said upper portion (41) to form the said upper element (30), a lower portion (51) that will form a lower support for the said pot (2) particularly when the said dispenser (1) is closed, the said lower portion (51) cooperating with the said base (40) to form the said lower element (31), and a so-called second axial connecting projection (52) between the said lid (50) and the said lower portion (51), the said second axial projection (52) having a height H2p>Hc and cooperating with the said first axial projection (42) to form the said lateral element (32), the said lid (50) and the said lower portion (51) forming elements typically parallel to and perpendicular to the said axial direction (10),
4) the said lower part (4) and upper part (5) cooperate particularly by means of an axial separation means (6), such that in the absence of the said manual pressure, the said lower and upper parts are kept at a distance from each other, and the said upper portion (41) and lower portion (51) are held close together,
so that
a) when the said dispenser (1) is closed, the said upper portion (41) and lower portion (51) apply an axial compression on the said pot (2), the said upper portion (41) then closing off and typically sealing the said upper opening (21),
b) and when the said axial manual pressure is applied on the said lid (50), the said lower portion (51) lowering by a height equal to the said axial travel distance ΔH, the said upper portion (41) and lower portion (51) move apart by a vertical distance equal to the said axial travel distance ΔH, the said pot (2) becomes free to move along a forwards lateral displacement to access the said upper opening (21), and the said dispenser (1) can thus change from a “closed” state to an “open” state and then reversibly change from the said “open” state to the said “closed” state by a backwards lateral displacement of the said pot (2).

2. Dispenser according to claim 1, in which the said lower part (4) forms a said first single-piece part, the said base (40), the said upper portion (41) and the said first axial projection (42) forming a single moulded part made of a thermoplastic material.

3. Dispenser according to claim 1, in which the said upper portion (41) forms or comprises a leak tight closing means for the said upper opening (21), the said leak tight closing means typically being formed by an add-on seal (43) fixed to the said upper portion (41) by its lower surface or by a sealing lip formed on the said upper portion (41) or on the pot (2).

4. Dispenser according to claim 1, in which the said upper part (5) forms a said second single-piece part, the said lid (50), the said lower portion (51) and the said second axial projection (52) forming a single moulded part made of a plastic material.

5. Dispenser according to claim 1, in which the said axial separation means (6) is a spring or an axial spring element (60).

6. Dispenser according to claim 5 in which the said spring (60) is a helical spring (61) typically placed between the said lid and the said upper portion.

7. Dispenser according to claim 5 in which the said spring or spring element (60) is formed by one or several flexible and resilient tabs (62) fixed to the said lower part and/or the said upper part.

8. Dispenser according to claim 1 in which the said first axial projection (42) and the said second axial projection (52) form two parallel axial panels (42′, 52′) free to slide with respect to each other and that cooperate to form the said lateral element (32) of the said frame (3), one of the two parallel axial panels (42′, 52′) being a front panel typically formed by the said second axial projection (52), the other panel being a back panel typically formed by the said first axial projection (42), the said front panel being the panel closest to the said pot.

9. Dispenser according to claim 1 in which the said pot comprises fixing means (23) to the said frame (3) and typically to the said lower portion (51), the said fixing means (23) enabling the said lateral displacement of the said pot (2).

10. Dispenser according to claim 1 in which the said lateral displacement is a forward 30 rotation or forward tipping, by an angle α in a transverse axial plane perpendicular to the said first and second axial projections (42, 52) or to the said front and back panels (42′, 52′) and with a radius of curvature R, the said angle α and the said radius of curvature R being chosen so as to be able to access the said upper opening (21) after the said tipping, the said angle α typically being approximately equal to α_{M} defined by tan α_{M}=Pc/Hc, where “PC” denotes the depth of the said pot (2) in the said transverse axial plane (11) and Hc is its height.

11. Dispenser according to any claim 9 in which the said fixing means (23) comprises at least one axial tab (230) cooperating with a complementary element (510) of the said lower portion (51), the said complementary element typically being formed by at least one guide element (510) of the said tab, the said guide element typically being formed by a groove or a recess (511) typically contained in the said transverse axial plane (11).

12. Dispenser according to claim 11 in which the said fixing means (23) comprises two parallel axial tabs (230) and the said guide means (510) is formed by two parallel recesses (511) in which the said axial tabs (230) are click fitted, such that the said pot (2) remains free to move with respect to the said lower portion (51), to enable the said lateral displacement.

13. Dispenser according to claim 10 in which the said lower portion (51) forms or comprises a plane rear portion (512) and a convex front portion (513) with the said radius of curvature R on its upper surface, and in which the bottom (22) of the said pot (2) has the same radius of curvature R, so as to cooperate like a ball joint with the said convex front portion (513), such that the said pot (2) can rotate by the said angle α about the said convex front portion (513) without moving away from the said lower portion (51).

14. Dispenser according to claim 1 in which the said base (40) comprises means (44) of propelling the said pot (2) forwards so as to automatically achieve the said lateral displacement of the said pot (2) so as to access the said upper opening (21), and thus make the said dispenser (1) open when the said manual pressure is applied onto the said lid (50).

15. Dispenser according to claim 14 in which the said forward propulsion means (44) comprises a lever (440) with an end rotating about a spindle (441) fixed to the said base (40), the said spindle (441) being in a horizontal plane (12) such that the said lever (440) can move in the said transverse axial plane (11), and a spring (442) acting on the said lever (440) so as to make the said pot (2) tip forwards as soon as the said pot (2) has been made free to move.

16. Dispenser according to claim 4 in which the said forward propulsion means (44) comprises a portion of axial rod (443) fixed to the said base (40) and located such that an upper end of the said portion of axial rod (443) bears on the bottom (22) of a lower portion of the said pot (2) during the said axial compression, thus tipping the said pot (2) forwards.

17. Dispenser according to claim 14 in which the said forward propulsion means (44) is coupled to the said axial travel distance ΔH, typically by a notch fixed to the said lower portion cooperating with a toothed wheel fixed to the said base, such that the said dispenser (1) remains open as long as the said manual pressure is applied to the said lid (50), the said dispenser (1) automatically closing as soon as the said manual pressure is removed.

18. Dispenser according to claim 14 in which the said forward propulsion means (44) is not coupled to the said axial travel distance ΔH, such that the said dispenser (1) remains open even if the said manual pressure applied on the said lid (50) is removed.

19. Dispenser according to claim 18 in which the said pot (2) includes an upper axial projection (24) cooperating with the said upper portion (41) such that a lateral manual pressure applied on the said pot displaces the said pot along a backwards lateral displacement and thus closes the said dispenser again.

20. Dispenser according to claim 14 in which the said forward propulsion means (44) is partially coupled to the said axial travel distance ΔH, such that the said dispenser (1) remains open even if the said manual pressure applied on the said lid (50) is removed, and such that all that is necessary is to apply a lateral manual pressure on the said pot to move the said pot along a backwards lateral displacement, thus closing the said dispenser.

21. Dispenser according to claim 1 in which the said pot (2) includes an inner pot (25) and an outer skirt (26) with typically homothetic sections, the said outer skirt (26) being connected to the said inner pot (25) by a plane shoulder (27), the said inner pot (25) comprising a bottom (250) and an inner skirt (251) provided with an upper rim (252) above the said plane shoulder (27), the said upper rim (252) cooperating with the said upper portion (41) in a leak tight manner when the said dispenser (1) is closed.

22. Dispenser according to claim 21 in which the said axial tab (230) is fixed to the said bottom (250) of the said inner pot (25), the said pot (2) and the said axial tab (230) typically forming a single-piece moulded part made of thermoplastic material.

23. Dispenser according to claim 21 in which the said outer skirt (26) comprises two lateral portions or concave lower edges (260) at its lower end with the said radius of curvature R, so as to cooperate with the said convex front part (513) of the said lower portion (51) like a ball joint, such that the said pot (2) can rotate by the said angle α about the said front convex portion with radius of curvature R without separating from the said lower portion (51).

24. Dispenser according claim 1 in which the said lid (50) of the said upper part (5) comprises an upper crown (500) and an upper rim (501) surrounding the said upper portion (41) over all or some of its axial thickness, and the said lower portion (51) of the said upper part (5) includes a central portion (514) acting as a support for the said pot and a lower rim (515) surrounding the said base (40) over some of its axial thickness, such that the said lower part (4) and upper part (5) are free to slide with respect to each other along the said axial travel distance ΔH.

25. Dispenser according to claim 1 in which the said pot (2) or the said outer skirt (26) of the said pot (2) has a square or rectangular or oval or circular shaped outer cross-section Sc perpendicular to the said axial direction.

26. Dispenser according to claim 1 having a height H when closed typically varying from 30 mm to 150 mm, and preferably from 50 mm to 110 mm, and a square or rectangular or oval or circular shaped maximum cross-section Sd_{M} perpendicular to the said axial direction, the said maximum cross-section Sd having its largest dimension Dd_{M} typically varying from 30 mm to 80 mm.

27. Dispenser according to claim 26 in which the said maximum cross-section is typically constant over the entire height H, at mid-height the said dispenser having a median cross-section comprising a median section Sb of the said lateral element (32) of the said frame (3) and a median section Sc of the said pot, typically such that Sd_{M}=Sb+Sc and such that the said sections are approximately complementary.

28. Dispenser according to claim 27 forming a cube or a right-angle parallelepiped with a square or rectangular plane cross-section.

29. Dispenser according to claim 28 in which the said median section Sb of the said lateral element (32) of the said frame (3) is rectangular or square, and the said median section Sc of the said pot is square or rectangular, so as to form a rectangular or square maximum cross-section Sd_{M}.

30. Dispenser according to claim 28 in which the said pot (2) or the said outer skirt (26) of the said pot (2), and the said second axial projection (52) have the same width L along a direction perpendicular to the said transverse axial plane (11), the said width L of the said dispenser typically varying from 30 mm to 80 mm, and have depths in the said transverse axial plane (11), denoted Pc for the said pot (2) or the said outer skirt (26) of the said pot (2) and Pp for the said second axial projection (52), the sum P=Pc+Pp corresponding to the depth P of the said dispenser typically varying from 20 mm to 60 mm.

31. Dispenser according to claim 26 in which the said maximum cross-section Sd_{M} is not necessarily constant over the entire height, the said dispenser having a median cross-section at mid-height comprising a median section Sb of the said lateral element (32) of the said frame (3) and a median section Sc of the said pot, so as to have Sc<Sd_{M}−Sb, the median sections Sb of the said lateral element (32) of the said frame (3) and Sc of the said pot not being complementary.

32. Process for manufacturing the dispenser (1) according claim 1 in which:
1) the said lower part (4), the said upper part (5) and the said pot (2) are formed or procured,
2) the said frame (3) is formed by assembly and typically by lateral click fitting of the said lower part (4) and upper part (5), the said pot (2) being assembled, typically by axial click fitting of the said upper part (5) to the said lower portion (51), either after or before having formed the said frame (3).
